(19) United States
(12) Patent Application Publication
(10) Pub. No.: US 2003/0139169 A1
(43) Pub. Date: Jul. 24, 2003

(54) Combination insulated container and entertainment center

(76) Inventor: Gregory Arreazola JR., Madera, CA (US)

Correspondence Address: Gregory Arreazola, Jr, 419 Fairview Avenue, Madera, CA, 93637, US

(21) Appl. No.: 10/050,345

(22) Filed: Jan. 18, 2002

(51) Int. Cl. H04B 1/08

(52) U.S. Cl. 455/344; 455/347; 455/350; 455/351

(57) ABSTRACT

What is disclosed is a combination thermal storage container and entertainment center. The container has a pair of hollow compartments with exterior sidewalls and interior sidewalls. The interior and exterior sidewalls are spaced apart to provide a thermal gap. First and second lid portions have hinges to connect the lids to the first and second compartment, respectively. First and second latching means are provided to secure the lids portions closed. A media playing means; such as a CD-player or cassette tape player, an antenna for receiving radio signals; a radio receiver means and tuning means and speaker are provided for playing audio output from the radio or media playing means. and a volume .adjusting means. The media player, radio receiver & tuning means and speakers are each affixed between one of said exterior sidewalls and a corresponding said interior sidewall. In one embodiment there is also affixed thereto a first aid kit secured to an exterior wall of said compartment and a holder with utensils.

### RELATED APPLICATIONS

There are no applications related to this invention anywhere in the world.

### BACKGROUND OF THE INVENTION

I. Field of the Invention

This invention relates to a combination thermal container and entertainment center, and more particularly to a cooler with integral radio, cassette, CD, DVD, speakers, and other built in conveniences.

II. Background

Thermally insulated coolers are well known in the prior art. For many years, families and picnic-goers have toted along coolers. A cooler is a thermal container which is typically a hollow enclosure which has insulation in the sidewalls which retards the heat exchange from the interior to the exterior of the enclosed box. Whether it contains hot items or more typically cold items such as ice, the items retain their hot or cold properties when placed in a thermally insulated container. Thus, Foods may be stored longer on a picnic or overnight outing by placing them in a chilled compartment. Food, drinks and other perishables tend to last longer when enclosed in such a container.

Also, combination devices such as coolers which include built-in audio systems are known in the prior art.

U.S. Pat. No. 5,447,041 discloses a cover apparatus having a recessed cavity with four sidewalls. An audio system is hingedly mounted on a sidewall of the recessed cavity and is moveable between a closed position wherein the audio system lies flat on the bottom wall within recessed cavity and an open position wherein the audio system extends outwardly from the recessed cavity. The audio system and cover panel are maintained in an open and upright position by a support stand.

U.S. Pat. No. 4,817,911 discloses a radio and cooler. The cooler incorporates a radio receiver unit into an indentation of a front wall of a four wall portable insulated cooler ice container. A separate rechargeable battery pack connected by wires to the radio receiver unit is integrated into the rear side of the lid of the cooler on the opposite side of the cooler's center of gravity from the radio receiver unit. The charging unit and the radio receiving unit counterbalance each other to provide stability to container.

U.S. Pat. No. 4,700,395 discloses a recreational cooler and speaker system which includes an audio signal input terminal such as an audio jack on an outer wall of a cooler for driving speaker elements mounted to the cooler enclosure through an electrical path within enclosure walls.

Thus there is a need for a combination thermal container and integral media player incorporating a plurality of additional features and a plurality of compartments for storage of contents of differing temperatures.

### SUMMARY OF THE INVENTION

What is disclosed is a combination thermal storage container and entertainment center. The container has a pair of hollow compartments with exterior sidewalls and interior sidewalls. The interior and exterior sidewalls are spaced apart to provide a thermal gap. First and second lid portions have hinges to connect the lids to the first and second compartment, respectively. First and second latching means are provided to secure the lids portions closed. A media playing means; such as a CD-player or cassette tape player, an antenna for receiving radio signals; a radio receiver means and tuning means and speaker are provided for playing audio output from the radio or media playing means. and a volume .adjusting means. The media player, radio receiver & tuning means and speakers are each affixed between one of said exterior sidewalls and a corresponding said interior sidewall. In one embodiment there is also affixed thereto a first aid kit secured to an exterior wall of said compartment and a holder with utensils.

The object of the present invention is to provide multiple conveniences and entertainment means integrally mounted in a portable thermal container. It is another object of the present invention to provide a thermally insulated dual compartment container with padded lids that double as seats, audio players and bottle openers with safety means.

Yet another object of the present invention to provide a combination thermal container and entertainment center which is portable and advantageously mounted upon casters.

A further object to provide in a combination insulatedcontainer a reclosable drain for melted ice and various spilled fluids. It is another object of the invention to provide a single device in which you can carry everything with you on a picnic or outdoor trip to the lake, mountains or park

Accordingly, I have provided the detailed description and drawings as follows.

### DESCRIPTION OF THE DRAWINGS

FIG. 1 is an isometric view of the combination insulatedcontainer and entertainment enter;

FIG. 2 is a right side view;

FIG. 3 is a plan view of the first aid kit in the open position

### DETAILED DESCRIPTION OF THE INVENTION

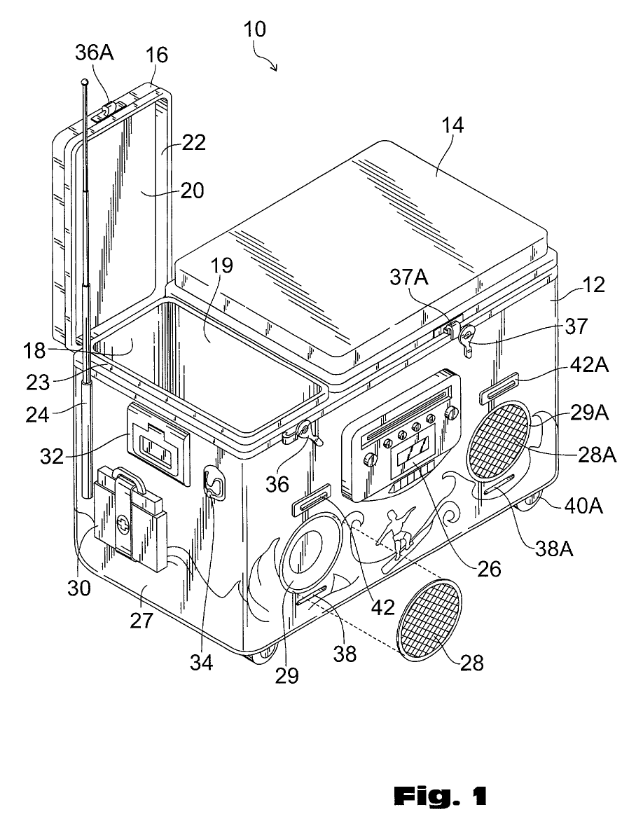

Referring first to FIG. 1, a combination insulatedcontainer and entertainment center is generally designated as 10. A hollow bottom portion 12 is attached by way of hinges (not shown), with a first lid portion 14 and a second lid portion 16. Lid portions 14, 16 are optionally cushioned so as to provide a comfortable seat when the lid is closed upon which the users may sit. First cavity 18 is shown in FIG. 1. Container 12 has a plurality of cavities, preferably two, in which to store items at different temperatures. The adjacent cavity (not shown), is located underneath first cushion lid portion 14 in the illustration of FIG. 1. Cavities 18, not shown are lined with water repellent material such as plastic, vinyl or other polymeric material. Partition wall 19 divides the adjacent cavities. The lid portions 14, 16 are hingedly attached to the lower container 12 and include interior portions 20, (not shown), with an associated peripheral flange 22 (not shown). The interior lid and flange portion may optionally hinge backward 180° to provide a surface on which to place food and drinks while preparing items for a picnic, for example. The peripheral flange 22 also provide an interlocking arrangement with raised shoulders 23, and (not shown), which when the lid is closed, are snugly fitted together to provide an additional thermal barrier to prevent loss of heat or infiltration of heat to and from the inner cavity 18 and (not shown). It should be noted that bottom portion 12 is a hollow container comprised of plurality of chambers, preferably two, which are open upwardly and when covered by a thermally insulated, generally flat cover provide a totally enclosed thermally insulated multiple chamber container.

In addition to the thermal container, entertainment media are integrally associated with the container 12. A media player comprising a radio, cassette and/or CD player 26, is inset into the molded front panel of container 12. The device 26 may be attached using screws, brackets or by an interference fit. Molded plastic front panel 25, includes a plurality of recesses (not shown) which accommodate a number of devices. A pair of mid-range speakers 28, 28A is moldably inserted on opposing sides of entertainment media player 26. Additionally, a pair of tweeters 42, 42A is also mounted on opposite sides of media player 26 and a pair of vents, 38, 38A are to ventilate the speaker chambers associated with mid-range speakers 28, 28A. Behind the speaker covers 28, 28A are speaker cones, 29, 29A on one side panel 27 of container 12 are mounted the number of auxiliary devices. A first-aid kit 30 is fixedly attached on side 27 as is a hinged handle 32 which has a corresponding panel on the opposite side (not shown) for carrying the container when desired. Also, an antenna 24 on side 27 is associated with and electrically connected to media player 26 through wiring (not shown) which is routed within container 12.

Also shown on FIG. 1 are a pair of latching mechanisms, 37, 37A and 36, 36A which are associated with each lid portion 16, 14 so as to provide a latching mechanism for maintaining the lids 16, 14 in a closed position.

It should be noted that the combination insulatedcontainer and entertainment center has four roller casters, 40 A, B, C, D mounted at the four bottom corners of container 12. Casters 40 A, B, C, D provide a rolling means by which to transport the container and its contents by pulling it rather than lifting the device.

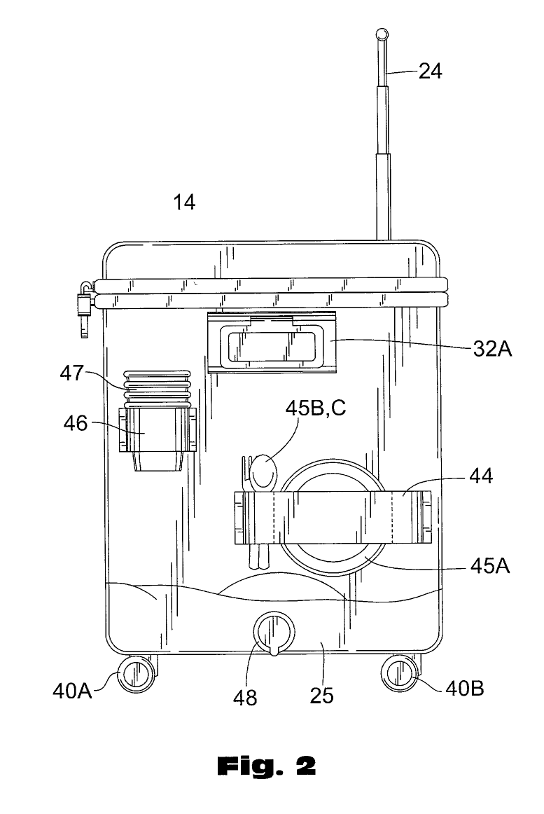

Referring next to FIG. 2, the sidewall 25 on the opposite side from sidewall 17 is shown. On sidewall 25, are mounted the second handle mechanism 32A, a cupholder 46 with cups 47. A strap holder 44 is fastened to sidewall 25 in such a manner as adapted to hold forks 45 B, C, spoons and plates 45A, as required. A drain cap 48 covers an opening which is in fluid communication with the interior of at least one of the interior chambers 18, (not shown). This drain plug 48 when opened permits the fluid contents of the internal cavity to drain to the exterior of the container 10. Ice may melt within the insulatedcontainer after a period of time and the drain plug is used to drain liquid before unpacking the contents.

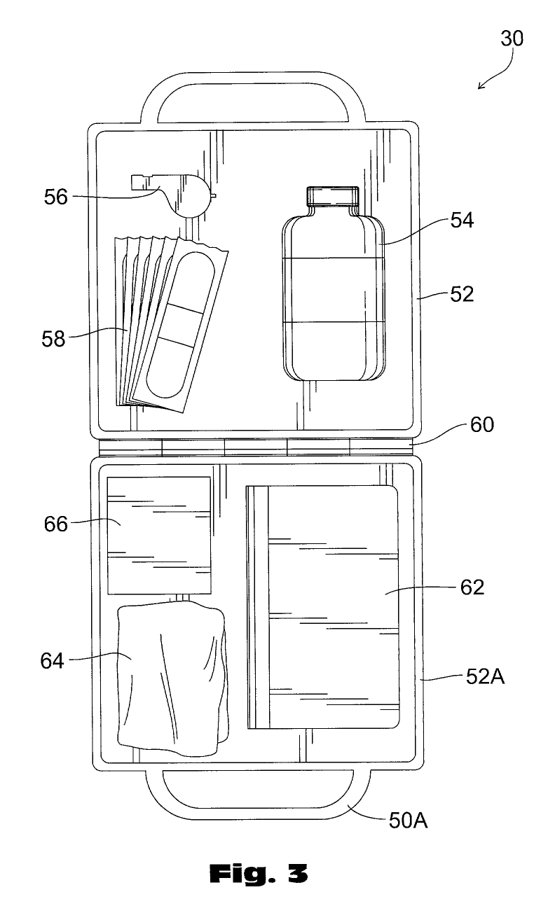

Referring next to FIG. 3, the first-aid kit 30 is illustrated. The first aid kit is opened to show the interior contents of first aid kit 30. The contents include a bottle of antiseptic liquid such as peroxide (OH) for disinfecting cuts and the like, a whistle for summoning help and a plurality of band-aids. Additionally, snake bite kit 66, a bandage 64, a first aid manual 62 are also included. The closure 52 is bifurcated into two portions and the entire kit may be carried by handles 50, 58 which are also divided in two sets. The bifurcated sections of the kit, 52, 52A are movably connected by way of hinge 60. Also optionally included on the sidewall of the device 27 is a bottle cap opener 34 to provide convenient access for opening bottles which may have pressed-fit caps associated with them.

According to the provisions of patent statutes, I have explained the principle, preferred construction and mode of operation of my invention and have illustrated and described what I now consider to represent its best embodiments. However, it should be understood that, within the scope of the appended claims, the invention may be practiced otherwise than as specifically illustrated and described.

1. A combination thermal storage container and entertainment center comprising a pair of hollow compartments with exterior sidewalls and interior sidewalls, said interior and exterior sidewalls in spaced relation to provide a thermal gap; first and second lid portions with hinges to connect said lids to the first and second compartment, respectively; a first and second latching means and a first and second hinge means; a media processing means; antenna for receiving signals; a radio receiver means and tuning means for audible output from the radio or media processing means; at least one speaker, and a volume adjusting means.

2. The combination storage container and entertainment center of claim 1, wherein said media processing, radio receiver, tuning means is affixed between one of said exterior sidewalls and a corresponding said interior sidewall.

3. The combination thermal storage container and entertainment center of claim 1 also comprising a media player processing means including a cassette tape player.

4. The combination thermal storage container and entertainment center of claim 1, also comprising a media player center which includes a compact disc media player.

5. The combination thermal storage container and entertainment center of claim 1 wherein also providing a first aid kit secured to an exterior wall of said compartment and means for holding utensils.

6. The combination thermal storage container and entertainment center of claim 1 also including a pair of handles on opposing sides with hinge mechanisms to facilitate lifting of said device.

7. The combination thermal storage container and entertainment center of claim 1 wherein also having rollers.

8. The combination thermal storage container and entertainment center of claim 1 wherein also having a plug and closable drain which is in fluid communication with the interior of said compartment.

9. The combination thermal storage container and entertainment center of claim 5 wherein the first aid kit which is mounted to the compartment has a hinged box enclosure having a pair of opposing handle portions, a whistle, band-aid, antiseptic, first aid manual and snake bite kit.

10. The combination thermal storage container and entertainment center of claim 1 wherein said lids having cushioned pads disposed within said lid portions.
